(19) United States
(12) Patent Application Publication
(10) Pub. No.: US 2026/0127037 A1
(43) Pub. Date: May 7, 2026

(54) COMPUTING RESOURCE MANAGEMENT METHOD AND COMPUTING DEVICE

(71) Applicant: INDUSTRIAL TECHNOLOGY RESEARCH INSTITUTE, HSINCHU (TW)

(72) Inventors: Shih-Ming HUANG, Kaohsiung City (TW); Chien-Hung LEE, Kaohsiung City (TW); Chun-Chieh HUANG, Taoyuan City (TW); Ling-Kang WU, Taoyuan City (TW)

(21) Appl. No.: 19/189,282

(22) Filed: Apr. 25, 2025

(30) Foreign Application Priority Data
Nov. 7, 2024 (TW) 113142802

(51) Int. Cl. G06F 9/50

(52) U.S. Cl. CPC G06F 9/505

(57) ABSTRACT

A computing resource management method is suitable for managing a computing device including processing cores. Each of the processing cores respectively includes a plurality of processor threads. The processor threads are used to execute computational programs respectively. The computing resource management method includes following steps. A static computation demand is obtained. A thread demand quantity is set based on the static computation demand. An offlineable thread quantity is determined based on the thread demand quantity. A first portion of the processor threads is blocked from a computing resource pool, using each processing core as a smallest unit, according to the first offlineable thread quantity. The computational programs to be executed are allocated on the processor threads within the computation resource pool by a task scheduler.

### RELATED APPLICATIONS

This application claims priority to Taiwan Application Serial Number 113142802, filed Nov. 7, 2024, which is herein incorporated by reference.

### BACKGROUND

### Field of Invention

This disclosure relates to the field of computer computations, and relates to resource management and scheduling techniques in computational devices.

### Description of Related Art

As the computational capabilities of modern devices continue to improve, effectively managing and scheduling the computational resources of these devices has become a critical issue. Traditional resource management methods often fail to dynamically adapt to changes in system load, leading to resource waste or insufficient performance. This disclosure provides an improved computational resource management method aimed at enhancing resource utilization efficiency and reducing energy consumption.

### SUMMARY

The disclosure provides a computing resource management method suitable for managing a computing device including processing cores. Each of the processing cores respectively includes a plurality of processor threads. The processor threads are used to execute computational programs respectively. The computing resource management method includes obtaining a static computation demand; setting a first thread demand quantity based on the static computation demand; determining a first offlineable thread quantity based on the first thread demand quantity; blocking a first portion of the processor threads from a computing resource pool, using each processing core as a smallest unit, according to the first offlineable thread quantity; and allocating, by a task scheduler, the computational programs to be executed on the processor threads within the computation resource pool.

The disclosure provides a computing device, which includes processing cores. The processing cores respectively include processor threads. The processor threads are used to execute computational programs. Each processing core has an adjustable operating frequency. The processing cores are configured to run a task scheduler and a computational resource regulator. The computational resource regulator is configured to: calculate a static computation demand based on an application expected load; set a first thread demand quantity based on the static computation demand; determine a first offlineable thread quantity based on the first thread demand quantity; and, block a first portion of the processor threads from a computing resource pool, using each processing core as a smallest unit, according to the first offlineable thread quantity. The task scheduler is used to allocate the computational programs to be executed on the processor threads within the computation resource pool.

The disclosure provides a computing resource management method, which is suitable for managing a computing device including processing cores. Each of the processing cores respectively includes processor threads. The processor threads are used to execute computational programs respectively. The computing resource management method includes: dynamically detecting a real-time workload of the processor threads and setting a thread demand quantity; determining an offlineable thread quantity based on the thread demand; blocking a portion of the processor threads from a computing resource pool, using each processing core as a smallest unit, according to the offlineable thread quantity; and allocating the computational programs to be executed on the processor threads within the computation resource pool by a task scheduler.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a computing device according to some embodiments of the disclosure.

FIG. 2 is a flowchart illustrating a computing resource management method according to some embodiments of this disclosure.

FIG. 3 is a schematic diagram illustrating a first thread demand quantity according to some embodiments.

FIG. 4A is a schematic diagram illustrating an allocation of multiple computational programs among the processor threads without employing the computing resource management method of this disclosure.

FIG. 4B is a schematic diagram illustrating another allocation of multiple computational programs among the processor threads with employing the computing resource management method of this disclosure.

FIG. 5 is a flowchart illustrating a computing resource management method in accordance with some embodiments of this disclosure.

FIG. 6A, FIG. 6B, and FIG. 6C are schematic diagrams illustrating dynamic settings of the second thread demand volume under different real-time workloads.

FIG. 7A illustrates an example after blocking according to some steps.

FIG. 7B illustrates an example after a subsequent blocking based on some steps within the computing resource management method.

FIG. 8, which is a flowchart illustrating a computing resource management method according to some embodiments of the disclosure.

FIG. 9 is a schematic diagram illustrating a blocking result of computational resources according to step of the computing resource management method.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

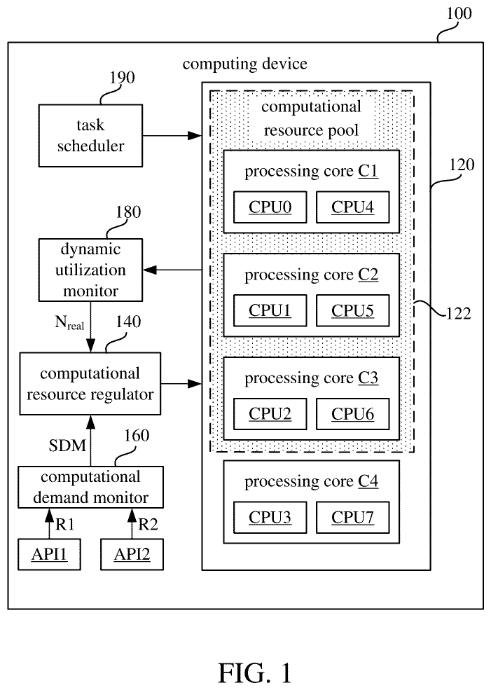

Reference is made to FIG. 1, which is a schematic diagram illustrating a computing device 100 according to some embodiments of the disclosure. In some embodiments, the computing device 100 includes a computational unit 120, a computational resource regulator 140, a computational demand monitor 160, a dynamic utilization monitor 180, and a task scheduler 190.

In some embodiments, the computing device 100 can be implemented by various forms of computing equipment, such as a server, personal computer, laptop, smartphone, tablet, embedded system, high-performance computing (HPC) cluster, or other similar devices. Servers are commonly used in data centers or enterprise environments and typically have multiple processing cores and a large number of processor threads to support high-performance computing and multitasking. Personal computers, laptops, smartphones, or tablets generally feature multi-core processors, requiring a balance between performance and power consumption, thus making resource management crucial for extending battery life and enhancing user experience. Embedded systems like IoT devices or control units in autonomous vehicles require efficient resource management to ensure reliability and real-time performance. High-performance computing clusters used in scientific research and engineering simulations need to manage extensive computational resources for complex computation tasks. The computing device 100, through effective resource management, can improve performance, reduce power consumption, and enhance system stability across various application scenarios.

A quantity of processing cores and a quantity of processor threads within the computing device 100 are constantly increasing to meet growing computational demands. However, disordered or excessive usage of these resources may lead to increased power consumption and performance bottlenecks. Therefore, managing the resources of processor threads across multiple processing cores is necessary. Through effective resource management, resources of processor threads can be dynamically allocated based on actual workloads, ensuring optimal resource allocation to improve the overall performance and energy efficiency of the system. Additionally, resource management can prevent unnecessary resource contention, reduce system latency, and prolong hardware lifespan, which are vital for applications requiring high performance and low energy consumption.

As shown in FIG. 1, the computational unit 120 of computing device 100 includes multiple processing cores C1, C2, C3, and C4, and each of them includes multiple processor threads. For example, the processing core C1 includes processor threads CPU0 and CPU4; the processing core C2 includes processor threads CPU1 and CPU5; the processing core C3 includes processor threads CPU2 and CPU6; and the processing core C4 includes processor threads CPU3 and CPU7.

In some embodiments, the processing cores C1, C2, C3, and C4 may be physical processing circuits in a central processing unit (CPU). Processing cores C1-C4 are physical components responsible for executing instructions and performing computations. On the other hand, the processor threads CPU0-CPU7 can be software/firmware programs, and each of the processor threads CPU0-CPU7 can operate independently from one another. Various instruction sets can be run on different processor threads CPU0-CPU7 simultaneously, so as to support multitasking and parallel computing functions.

A difference between processing cores C1-C4 and processor threads CPU0-CPU7 is that the processing cores are physical circuits, while the processor threads are virtual elements (e.g., software/firmware). The processing cores C1-C4 are the physical circuits within a processor, and the processing cores C1-C4 are utilized to execute some tasks, and a quantity of the processing cores within the processor is constrained by the available physical space on the chip.

On the other hand, the processor threads CPU0-CPU7 are virtual elements rather than physical circuits. The processor threads CPU0-CPU7 are software elements that allow a single core to execute two or more tasks simultaneously, using shared resources such as memory and cache. Each of the processor thread CPU0-CPU7 can execute one instruction (i.e., a computational program) at a given time and can quickly switch between instructions.

As shown in FIG. 1, the computational unit 120 includes four processing cores C1-C4. Each of the processing cores C1-C4 includes two processor threads. There are 4*2 processor threads for illustrative purposes. The disclosure is not limited to this quantity. In another embodiment, a computational unit 120 of the computing device 100 may include M processing cores, and each of the processing core can include N paired processor threads. In this case, there will be M*N processor threads within the computing device 100. M and N are positive integers. For simplicity in subsequent examples, the quantities shown in FIG. 1 will be utilized for demonstration.

In some embodiments, these processor threads CPU0-CPU7 are used to execute multiple computational programs, each corresponding to different task demands. For example, on a server, the computational programs executed by processor threads CPU0-CPU7 might include web server request processing, database queries, or background computing tasks. On a personal computer, computational programs could include document processing, checking emails, or multimedia playback. On a smartphone, computational programs might include application interface updates, network data synchronization, or background music playback. These computational programs can be run on multiple processor threads CPU0-CPU7 for parallel processing to enhance a processing efficiency and a response time of the computing device 100.

To rationally allocate tasks of computational programs to suitable processing cores C1-C4 and processor threads CPU0-CPU7, the computational resource regulator 140, the computational demand monitor 160, the dynamic utilization monitor 180, and the task scheduler 190 in some embodiments are used for managing computational resources. In an embodiment, the computational resource regulator 140 is used to regulate a quantity of the processing cores included in the computational resource pool 122. Implementations will be further described in subsequent embodiments.

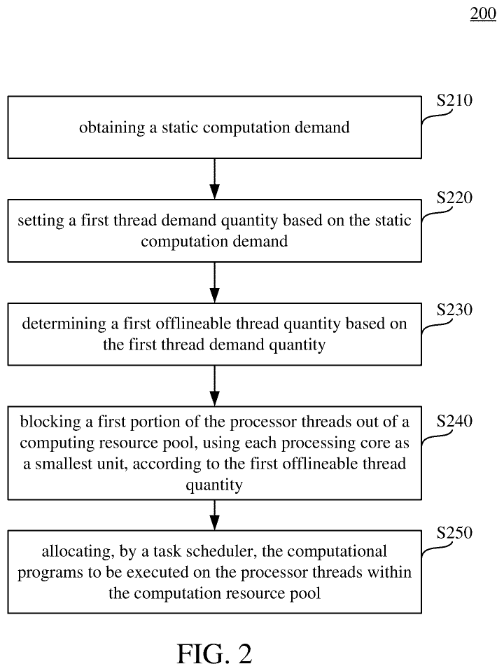

Reference is further made to FIG. 2, which is a flowchart illustrating a computing resource management method 200 according to some embodiments of this disclosure. The computing resource management method 200 can be executed by the computing device 100 shown in FIG. 1. As shown in FIG. 1 and FIG. 2, in step S210 of the computing resource management method 200, the computational demand monitor 160 obtains a static computation demand SDM about the computational programs to be executed.

For example, the computational demand monitor 160 is able receive an expected load R1 of a first application via a Representational State Transfer (RESTful) application program interface API1. The expected load R1 of the first application can include various forms of data that describe the resource demands of the RESTful application over a future period. Specifically, the expected load R1 might include a number of requests (e.g., the number of HTTP requests received within a specific timeframe, which helps predict server load), data processing volume (e.g., the size of files to be uploaded or downloaded, or the scale of datasets needing computation), a number of users (the expected number of concurrent users online, which can affect concurrent processing demands of the system), computational tasks (the number and complexity of computational tasks that need to be performed, such as image processing, data analysis, or machine learning inference), and/or usage indicators of resources (e.g., the expected usage of processing cores, memory, and network bandwidth).

Moreover, the computational demand monitor 160 is able to receive an expected load R2 of a second application via a third-party application interface API2. The expected load R2 of the second application describes the resource demands of a third-party application over a future period. Specifically, the expected load R2 may include a number of requests, data processing volume, a number of users, computational tasks, and/or usage indicators of resources.

The computational demand monitor 160 is configured to calculate the static computation demand SDM based on the expected load R1 and the expected load R2. In an embodiment, the static computation demand SDM represents a total estimated expected load of RESTful applications and third-party applications over a future period. This static computation demand SDM is able to reflect the total quantity of various computational tasks that the computing device 100 is expected to process over a future period.

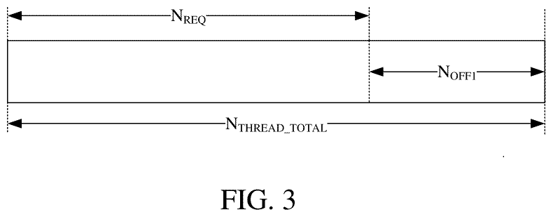

As shown in FIG. 1 and FIG. 2, in step S220 of the computing resource management method 200, the computational resource regulator 140 sets the first thread demand quantity based on the static computation demand SDM. Reference is further made to FIG. 3, which is a schematic diagram illustrating a first thread demand quantity N_{REQ} according to some embodiments.

In step S220, the computational resource regulator 140 is configured to determine how many threads must operate in parallel to meet the static computation demand SDM. A result of this determination is regarded as the first thread demand volume N_{REQ}.

Subsequently, in step S230, the computational resource regulator 140 is configured to determine the first offlineable thread quantity N_{OFF1} based on the first thread demand quantity N_{REQ}. As shown in FIG. 3, the difference between the total number of processor threads N_{THREAD_TOTAL} and the first thread demand quantity N_{REQ} determines the first offlineable thread quantity N_{OFF1}.

Subsequently, the computational resource regulator 140 is able to regulate a number of processing cores included in the computational resource pool 122 based on the first offlineable thread quantity N_{OFF1}.

Then, in step S240, the computational resource regulator 140, based on the first offlineable thread quantity N_{OFF1}, blocks a subset of processor threads CPU0-CPU7 from the computing resource pool 122, using each processing core as a smallest unit, according to the first offlineable thread quantity N_{OFF1}.

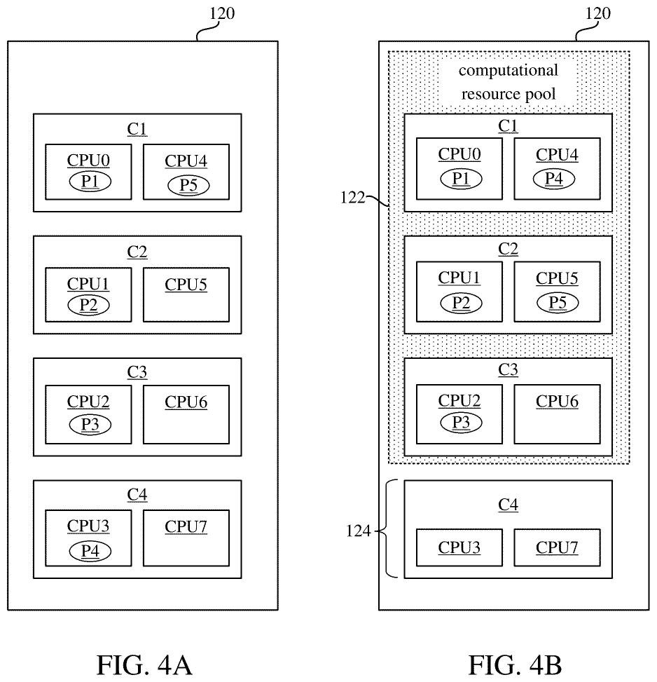

Reference is further made to FIG. 4A and FIG. 4B. FIG. 4A is a schematic diagram illustrating an allocation of multiple computational programs P1-P5 among the processor threads CPU0-CPU7 without employing the computing resource management method 200 of this disclosure. FIG. 4B is a schematic diagram illustrating another allocation of multiple computational programs P1-P5 among the processor threads CPU0-CPU7 with employing the computing resource management method 200 of this disclosure.

As shown in FIG. 4A, it is assumed that the first thread demand quantity N_{REQ} calculated by the computational demand monitor 160 is five, and it indicates that five computational programs P1-P5 are expected to execute concurrently. The task scheduler 190 is utilized to allocate these five computational programs P1-P5 to the processor threads CPU0-CPU7. In some embodiments, the task scheduler 190 may utilize a Linux processor scheduler.

Typically, the Linux processor scheduler tends to distribute the computational programs P1-P5 as evenly as possible across all online processing cores. As shown in FIG. 4A, according to the allocation logic of the Linux processor scheduler, the computational programs P1-P5 will be distributed as evenly as possible across processing cores C1-C4. In this case, two computational programs P1 and P5 are allocated on the processing core C1, and one computational program (e.g., the computational program P2, P3 or P4) is respectively allocated on each of the processing cores (e.g., the processing core C2, C3 or C4). In this case, because at least one computational program is assigned to each of the processing cores C1-C4, each core will need to maintain a standard operating frequency, a standard operating voltage or a standard operating current to meet the needs of computational programs P1-P5.

In contrast, based on the computing resource management method 200 in this disclosure, in response to that the first thread demand quantity N_{REQ} is 5, the first offlineable thread quantity N_{OFF1} is calculated to be 3. In step S240, the computational resource regulator 140 further calculates the number of cores that can be blocked as follows:

k*N≤N_{OFF1}

In aforesaid equation, k is the number of processing cores to be blocked, and k is a positive integer between 0 and M. N is the number of processor threads per processing core. In the current example, with N_{OFF1}=3 and N=2, a maximum value of k is equal to 1.

In this example, as shown in FIG. 4B, the computational resource regulator 140 selects processor threads CPU3 and CPU7 within the processing core C4 (as the smallest unit) as a first portion of the processor threads 124. The computational resource regulator 140 is configured to block the first portion (i.e., the processor threads CPU3 and CPU7) from the computation resource pool 122. In this situation, the processing core C4 is set offline by the computational resource regulator 140, which reduces the operating frequency, the operating voltage, or the operating current of the offline processing core C4, consequently reducing its power consumption and thereby lowering the overall energy consumption of the computing device 100.

Subsequently, in step S250, the task scheduler 190 allocates the computational programs P1-P5 to the processor threads CPU0, CPU1, CPU2, CPU4, and CPU5 within the computation resource pool 122.

In some embodiments, the task scheduler 190 can be implemented by a Linux processor scheduler. In this case, since the processor threads CPU3 and CPU7 of processing core C4 have been excluded from the computation resource pool 122, the Linux processor scheduler is executed to arrange computational resources within the computation resource pool 122. Therefore, based on inherent allocation logic of the Linux processor scheduler, the task scheduler 190 is able to arrange the computational programs P1-P5 to be executed on the online processing cores C1-C3, without assigning the computational programs P1-P5 to the offline processing core C4. In other words, the task scheduler 190 will not assign the computational programs to N processor threads within the offline processing core C4 (in this case, N=2). This approach is able to concentrate the computational programs on specific processing cores (such as the processing cores C1-C3) without altering the inherent allocation logic of the Linux processor scheduler. In this scenario, it ensures that the computing device 100 is able to allocate sufficient computational resources to process the computational programs P1-P5 timely while reducing an overall energy consumption of the computing device 100.

In some embodiments, the computational resource regulator 140, the computational demand monitor 160, the dynamic utilization monitor 180 and the task scheduler 190 shown in FIG. 1 can be implemented by software, such as software programs executed by the computational unit 120. In another embodiment, these components can be implemented by software executed by a microcontroller unit (MCU, not shown) within the computing device 100.

Aforementioned embodiments determine subsequent blocking operations based on the static computation demand SDM estimated from the expected application loads. However, this disclosure is not limited thereto. In practical applications, besides estimating static resource demands for a future period, computational loadings during the actual execution of computational programs P1-P5 may vary dynamically. Some embodiments of this disclosure can further adjust based on these dynamic changes of computational loadings.

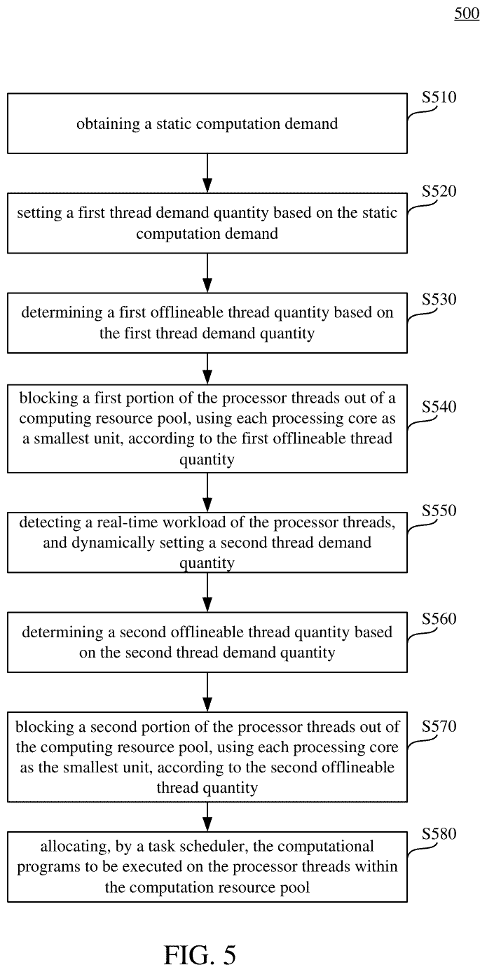

Reference is further made to FIG. 5, which is a flowchart illustrating a computing resource management method 500 in accordance with some embodiments of this disclosure. The computing resource management method 500 can be executed by the computing device 100 shown in FIG. 1. Steps S510, S520, S530, and S540 in the computing resource management method 500 are similar to steps S210, S220, S230, and S240 in the embodiment shown in FIG. 2, and are not repeated again.

As shown in FIG. 5, the computing resource management method 500 includes steps S510-S540 (which regulate based on the static computation demand SDM) and further includes steps S550-S570 to reflect a real-time workload Nᵣₑₐₗ of the processor threads.

As shown in FIG. 1 and FIG. 5, in step S550, the dynamic utilization monitor 180 detects the real-time workload Nᵣₑₐₗ of the processor threads CPU0-CPU7. Based on this real-time workload Nᵣₑₐₗ, the computational resource regulator 140 dynamically sets a second thread demand quantity.

In the previous example from FIG. 4B, according to the estimation of static computation demand SDM, five computational programs P1-P5 might be assigned to five processor threads CPU0, CPU1, CPU2, CPU4, and CPU5. However, during actual execution, it may not strictly follow the static estimations, e.g., computational programs P2 and P4 might temporarily stop while waiting for network packets (resulting in only three programs operating simultaneously in reality), or computational program P1 might call or trigger two additional programs (requiring up to seven programs to operate at once).

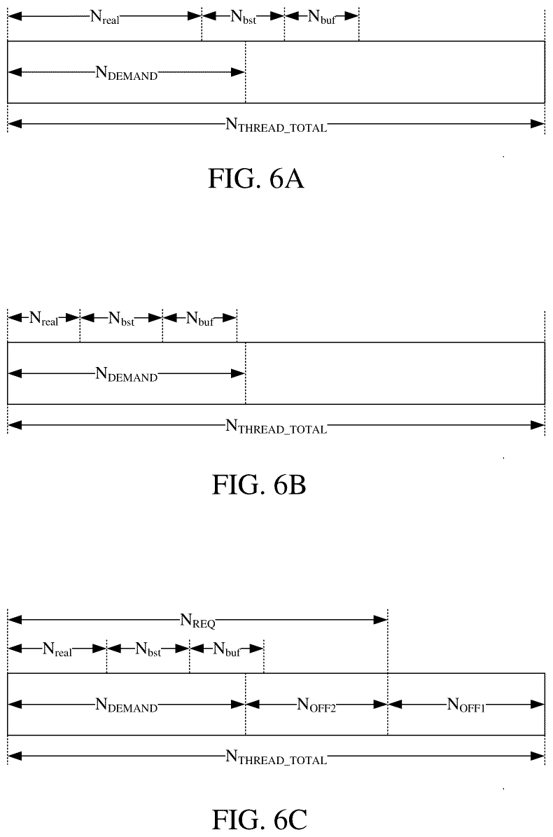

Reference is further made to FIG. 6A, FIG. 6B, and FIG. 6C. FIG. 6A, FIG. 6B, and FIG. 6C are schematic diagrams illustrating dynamic settings of the second thread demand volume N_{DEMAND} under different real-time workloads Nᵣₑₐₗ.

FIG. 6A illustrates a scenario of high real-time workload Nᵣₑₐₗ, which indicate more processor threads are required to satisfy active computational programs. In the computing resource management method 500, step S550 involves the regulator 140 comparing a sum of the real-time workload Nᵣₑₐₗ and a burst workload N_{bst} against the second thread demand quantity N_{DEMAND} currently adopted. The second thread demand quantity N_{DEMAND} currently adopted may be the quantity calculated in a previous sampling interval.

As shown in FIG. 6A, if the sum of the real-time workload Nᵣₑₐₗ and the burst workload N_{bst} exceeds the second thread demand volume N_{DEMAND} currently adopted, it suggests that the real-time workload Nreal is high and overloaded. In this case, the regulator 140 will increase the second thread demand quantity N_{DEMAND}. The burst workload N_{bst} refers to a possible number of processor threads required for handling sudden burst workloads.

FIG. 6B illustrates a scenario with low real-time workload Nᵣₑₐₗ. In step S550 of method 500, the computational resource regulator 140 compares the currently adopted second thread demand volume N_{DEMAND} with a sum of the real-time workload Nᵣₑₐₗ, the burst workload N_{bst}, and a buffer reserve value N_{buf}.

As shown in FIG. 6B, if the second thread demand volume NDEMAND currently adopted is greater than the sum of the real-time workload Nᵣₑₐₗ, the burst workload N_{bst} and the buffer reserve value N_{buf}, it indicates that the real-time workload Nᵣₑₐₗ is light and underloaded (possibly due to computational programs are halted or waiting for data), the computational resource regulator 140 is configured to decrease the second thread demand quantity N_{DEMAND}.

In scenarios meeting the conditions of FIG. 6A (i.e., heavy workload) or FIG. 6B (i.e., light workload), the computing resource management method 500 can dynamically adjust a level of the second thread demand quantity N_{DEMAND} in reference with the real-time workload Nᵣₑₐₗ.

FIG. 6C illustrates a scenario that the detected real-time workload Nᵣₑₐₗ and the second thread demand volume N_{DEMAND} currently adopted are aligned. As shown in FIG. 6C, the second thread demand volume N_{DEMAND} is higher than the sum of the real-time workload Nreal and the burst workload Nbst, and is not exceeding the sum of the burst workload Nbst and the buffer reserve value Nbuf, it indicates that the second thread demand volume N_{DEMAND} in FIG. 6C is currently at a proper level.

As illustrated in FIG. 6C, the second thread demand quantity N_{DEMAND} determined in real-time is lower than the first thread demand quantity N_{REQ} calculated based on the static computation demand SDM. Subsequently, in step S560, the computational resource regulator 140 determines a second offlineable thread quantity N_{OFF2} based on the second thread demand quantity N_{DEMAND}. As depicted in FIG. 6C, a second offlineable thread quantity N_{OFF2} is determined by a difference between the first thread demand quantity N_{REQ} and the second thread demand quantity N_{DEMAND}, and the second offlineable thread quantity N_{OFF2} does not overlap with the first offlineable thread quantity N_{OFF1} calculated in the step S530.

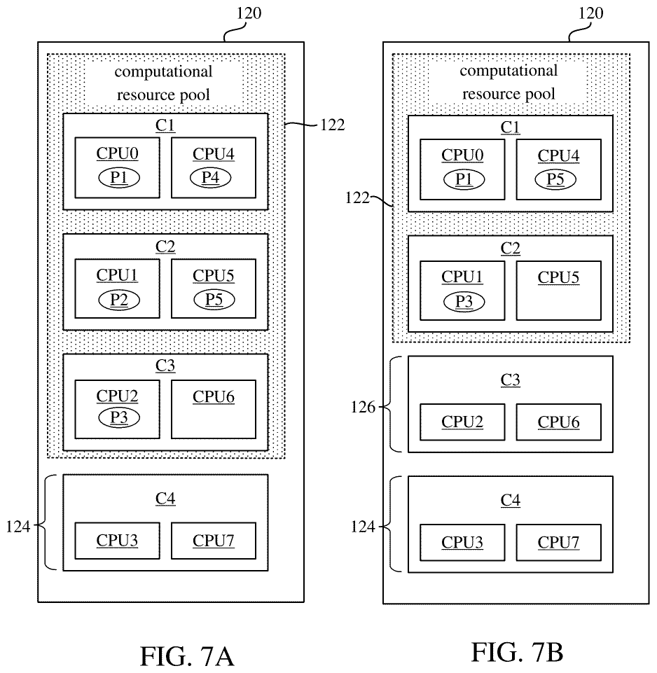

In step S570, based on the second offlineable thread quantity N_{OFF2}, some of the processor threads (as a second portion of threads) are blocked from the computation resource pool 122, using each processing core as the smallest unit. Reference is further made to FIG. 7A and FIG. 7B. FIG. 7A illustrates an example after blocking according to steps S510, S520, S530, and S540. FIG. 7B illustrates an example after a subsequent blocking based on steps S550, S560, and S570 within the computing resource management method 500.

In FIG. 7A, the computational resource regulator 140 selects processor threads CPU3 and CPU7 within the processing core C4 (as the smallest unit) as the first portion of the processor threads 124, and blocks the processor threads CPU3 and CPU7 from the computation resource pool 122. In this example, five computational programs P1-P5 are allocated to the five processor threads CPU0, CPU1, CPU2, CPU4, and CPU5 within the computation resource pool 122.

FIG. 7B illustrates a scenario that, based on a detection result of the real-time workload detection Nreal, the computational programs P2 and P4 are found to be temporarily halted with no actual load imposed. Therefore, the second thread demand quantity N_{DEMAND} is determined to be 3, and the second offlineable thread quantity N_{OFF2} is calculated to be 2. The computational resource regulator 140 may select the processor threads CPU2 and CPU6 within the processing core C3 (as the smallest unit) as the second portion 126, and block the processor threads CPU2 and CPU6 from the computation resource pool 122.

In this case, the computation resource pool 122, after two blocking phases of steps S510 to S570, includes the processor threads CPU0, CPU1, CPU4, and CPU5 within the processing cores C1 and C2. Based on this result, in step S580, the task scheduler 190 allocates the computational programs P1, P3, and P5 to the processor threads within the computation resource pool 122. The task scheduler 190 does not assign these programs to the 2*N processor threads within the processing cores C3 and C4.

In this case, the computational resource regulator 140 sets processing cores C3 and C4 to offline state, so as to reduce the operating frequency, the operating voltage, or the operating current on these processing cores C3 and C4. The power consumption on these processing cores C3 and C4 are reduced, so as to reduce an overall energy consumption of the computing device 100.

In the embodiment shown in FIG. 5, two blocking phases involving a static estimation (steps S510-S540) followed by a dynamic real-time detection (steps S550-S570) are disclosed. However, this disclosure is not limited to such a two-phase approach. In another embodiment, dynamic real-time detection can be executed independently for blocking.

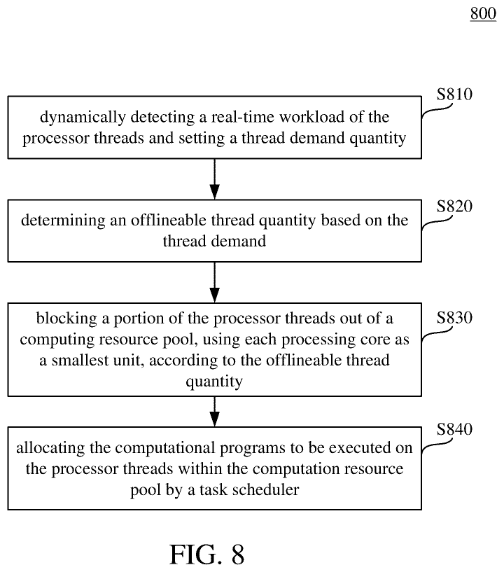

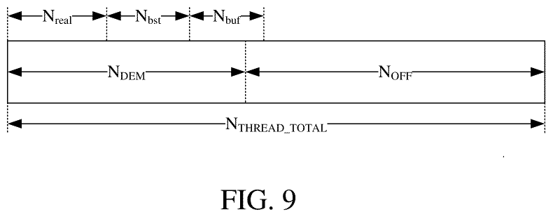

Reference is further made to FIG. 8, which is a flowchart illustrating a computing resource management method 800 according to some embodiments of the disclosure. As shown in FIG. 8, the computing resource management method 800 includes steps S810, S820, S830, and S840, which are similar to steps S550, S560, S570, and S580 in aforementioned embodiment shown in FIG. 5. The computing resource management method 800 can be executed by the computing device 100 shown in FIG. 1. Reference is further made to FIG. 9, which is a schematic diagram illustrating a blocking result of computational resources according to step S810, S820 and S830 of the computing resource management method 800.

As illustrated in FIG. 1, FIG. 8, and FIG. 9, in step S810, the dynamic utilization monitor 180 detects the real-time workload Nᵣₑₐₗ on the processor threads CPU0-CPU7, and the computational resource regulator 140 dynamically sets a thread demand quantity N_{DEM} based on the real-time workload Nreal.

In step S810, the computational resource regulator 140 compares whether the sum of the real-time workload Nᵣₑₐₗ and the burst workload N_{bst} reaches the thread demand quantity N_{DEM} currently adopted. If this sum exceeds the thread demand quantity N_{DEM} currently adopted, step S810 is executed to increase the thread demand quantity N_{DEM}. Details of this operation can be found in the embodiment illustrated in FIG. 6A.

On the other hand, the computational resource regulator 140 determines whether the thread demand volume N_{DEM} currently adopted exceeds the sum of the real-time workload Nᵣₑₐₗ, the burst workload N_{bst}, and the buffer reserve value N_{buf}. If it does, step S810 is executed to reduce the thread demand quantity N_{DEM}. Details for this operation can be found in the embodiment illustrated in FIG. 6B.

Step S820 is executed to determine the offlineable thread quantity N_{OFF} based on the thread demand volume N_{DEM}. Differing from the embodiment shown in FIG. 5, the offlineable thread quantity N_{OFF} in FIG. 8 and FIG. 9 is determined based on the thread demand quantity N_{DEM}, which is dynamically detected.

In step S830, the computational resource regulator 140 is configured to block a portion of processor threads from the computation resource pool 122, using each processing core as the smallest unit, based on the offlineable thread quantity N_{OFF}.

In step S840, the task scheduler 190 is configured to allocate the computational programs to multiple processor threads within the computation resource pool 122.

In some embodiments, the task scheduler 190 can be implemented by a Linux processor scheduler. The computing resource management method 800 is able to block some of the processing cores directly according to the real-time workload Nᵣₑₐₗ, and the computational tasks are allocated by the Linux processor scheduler to the processor threads within the computation resource pool 122. This approach ensures that computational programs are concentrated on specific cores within the computation resource pool 122 without altering the inherent allocation logic of the Linux processor scheduler. It can ensure the computational program can immediate access to required resources and it can reduce an overall power consumption on the computing device 100.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A computing resource management method, suitable for managing a computing device comprising a plurality of processing cores, wherein each of the plurality of processing cores comprises a plurality of processor threads, and the plurality of processor threads are respectively used to execute a plurality of computational programs, the computing resource management method comprising:
obtaining a static computation demand;
setting a first thread demand quantity based on the static computation demand;
determining a first offlineable thread quantity based on the first thread demand quantity;
blocking a first portion of the plurality of processor threads from a computing resource pool, using each processing core as a smallest unit, according to the first offlineable thread quantity; and
allocating, by a task scheduler, the computational programs respectively to the plurality of processor threads within the computation resource pool.

2. The computing resource management method as described in claim 1, further comprising:
detecting a real-time workload of the processor threads, and dynamically setting a second thread demand quantity;
determining a second offlineable thread quantity based on the second thread demand quantity; and
blocking a second portion of the processor threads from the computing resource pool, using each processing core as the smallest unit, according to the second offlineable thread quantity.

3. The computing resource management method as described in claim 2, wherein dynamically setting the second thread demand quantity is based on:
comparing whether a sum of the real-time workload and a burst workload reaches the second thread demand quantity currently adopted, and increasing the second thread demand quantity in response to that the sum of the real-time workload and the burst workload is greater than the second thread demand quantity currently adopted; and
comparing whether the second thread demand quantity currently adopted is greater than a sum of the real-time workload, the burst workload and a buffer reserve value, and decreasing the second thread demand quantity in response to that the second thread demand quantity currently adopted exceeds the sum of the real-time workload, the burst workload and the buffer reserve value.

4. The computing resource management method as described in claim 1, wherein the task scheduler comprises a Linux processor scheduler.

5. The computing resource management method as described in claim 1, comprising:
receiving a first application expected load via a Representational State Transfer (RESTful) application interface;
receiving a second application expected load via a third-party application interface; and
calculating the static computation demand based on the first application expected load and the second application expected load.

6. The computing resource management method as described in claim 1, wherein the computing device comprises M processing cores, each of the M processing cores comprising N paired processor threads, such that the computing device comprises M*N processor threads in total, and wherein the computing resource management method is configured to block k*N processor threads from the computation resource pool, wherein M and N are positive integers, and k is a positive integer between 0 and M.

7. The computing resource management method as described in claim 6, wherein in response to the k*N processor threads being blocked from the computation resource pool, the task scheduler is configured not to allocate the computational programs to the k*N processor threads, and the computing resource management method is further configured to reduce an operating frequency, an operating voltage, or an operating current of at least one of the k processing cores.

8. A computing device comprising:
a plurality of processing cores, each of the processing cores respectively comprises a plurality of processor threads, the processor threads being used to execute a plurality of computational programs, each processing core having an adjustable operating frequency, the processing cores configured to run a task scheduler and a computational resource regulator, the computational resource regulator is configured to:
calculate a static computation demand based on an application expected load;
set a first thread demand quantity based on the static computation demand;
determine a first offlineable thread quantity based on the first thread demand quantity; and
block a first portion of the processor threads from a computing resource pool, using each processing core as a smallest unit, according to the first offlineable thread quantity,
wherein the task scheduler is used to allocate the computational programs to be executed on the processor threads within the computation resource pool.

9. The computing device as described in claim 8, wherein the processing cores are further configured to run a dynamic utilization monitor, the dynamic utilization monitor is configured to detect a real-time workload of the processor threads, and the computational resource regulator is configured to:
dynamically set a second thread demand quantity based on the real-time workload;
determine a second offlineable thread quantity based on the second thread demand quantity; and
block a second portion of the processor threads from the computing resource pool, using each processing core as a smallest unit, according to the second offlineable thread quantity.

10. The computing device as described in claim 9, wherein the computational resource regulator dynamically sets the second thread demand quantity based on:
comparing whether a sum of the real-time workload and a burst workload reaches the second thread demand quantity currently adopted, and increasing the second thread demand quantity in response to that the sum of the real-time workload and a burst workload exceeds the second thread demand quantity currently adopted; and
comparing whether the second thread demand quantity currently adopted exceeds a sum of the real-time workload, the burst workload and a buffer reserve value, and decreasing the second thread demand quantity in response to that the second thread demand quantity currently adopted exceeds the sum of the real-time workload, the burst workload and the buffer reserve value.

11. The computing device as described in claim 8, wherein the task scheduler comprises a Linux processor scheduler.

12. The computing device as described in claim 8, wherein the processing cores are further configured to run a computation demand monitor, the computation demand monitor is configured to:
receive a first application expected load via a Representational State Transfer (RESTful) application interface;
receive a second application expected load via a third-party application interface; and
calculate the static computation demand based on the first application expected load and the second application expected load.

13. The computing device as described in claim 8, wherein the computing device comprises M processing cores, each processing core respectively comprises N paired processor threads, the computing device comprising M*N processor threads, and the computational resource regulator blocks k*N processor threads from the computation resource pool, M and N are positive integers, and k is a positive integer between 0 and M.

14. The computing device as described in claim 13, wherein in response to that the k*N processor threads are blocked outside the computation resource pool, the task scheduler does not allocate the computational programs to be executed on the k*N processor threads, and the computational resource regulator is configured to reduce an operating frequency, an operating voltage, or an operating current on one of the k processing cores.

15. The computing device as described in claim 8, wherein the computing device comprises a server, a personal computer, a laptop, a smartphone, a tablet computer, an embedded system or a high-performance computing cluster.

16. A computing resource management method, suitable for managing a computing device comprising a plurality of processing cores, each of the processing cores respectively comprising a plurality of processor threads, the processor threads being used to execute a plurality of computational programs respectively, the computing resource management method comprising:
dynamically detecting a real-time workload of the processor threads and setting a thread demand quantity;
determining an offlineable thread quantity based on the thread demand;
blocking a portion of the processor threads from a computing resource pool, using each processing core as a smallest unit, according to the offlineable thread quantity; and
allocating the computational programs to be executed on the processor threads within the computation resource pool by a task scheduler.

17. The computing resource management method as described in claim 16, wherein dynamically setting the thread demand quantity is based on:
comparing whether a sum of the real-time workload and a burst workload reaches the thread demand quantity currently adopted, and increasing the thread demand quantity in response to that the sum of the real-time workload and the burst workload exceeds the thread demand quantity currently adopted; and
comparing whether the thread demand quantity currently adopted exceeds a sum of the real-time workload, the burst workload and a buffer reserve value, and decreasing the thread demand quantity in response to that the thread demand quantity currently adopted exceeds the sum of the real-time workload, the burst workload and the buffer reserve value.

18. The computing resource management method as described in claim 16, wherein the task scheduler comprises a Linux processor scheduler.

19. The computing resource management method as described in claim 16, wherein the computing device comprises M processing cores, each processing core respectively comprises N paired processor threads, the computing device comprising M*N processor threads, and the computing resource management method is configured to block k*N processor threads from the computation resource pool, M and N are positive integers, and k is a positive integer between 0 and M.

20. The computing resource management method as described in claim 19, wherein in response to that the k*N processor threads are blocked outside the computation resource pool, the task scheduler does not allocate the computational programs to be executed on the k*N processor threads, and the computing resource management method is configured to reduce an operating frequency, an operating voltage, or an operating current on one of the k processing cores.
